(19) United States
(12) Patent Application Publication
(10) Pub. No.: US 2011/0061890 A1
(43) Pub. Date: Mar. 17, 2011

(54) SHIELDING SEAM LOCATION IN A COAXIAL CABLE

(75) Inventor: Alan John Amato, Cheshire, CT (US)

(73) Assignee: JOHN MEZZALINGUA ASSOCIATES, INC., East Syracuse, NY (US)

(21) Appl. No.: 12/560,354

(22) Filed: Sep. 15, 2009

(51) Int. Cl. H01B 11/18

(52) U.S. Cl. 174/107

(57) ABSTRACT

Shielding seam location in a coaxial cable. In one example embodiment, a coaxial cable includes a center conductor surrounded by a dielectric, an inner conductive tape surrounding the dielectric, a conductive braid surrounding the inner conductive tape, an outer conductive tape surrounding the conductive braid, and a jacket surrounding the outer conductive tape. The outer conductive tape includes an aluminum layer, a seam in which two edges of the aluminum layer overlap one another, and means for visibly manifesting the location of the seam.

### BACKGROUND

Typical coaxial cable includes one or more layers of conductive materials for radio frequency (RF) shielding. One common type of shielding is a conductive tape that attenuates interfering electromagnetic fields in the high frequency range. Another common type of shielding is a conductive braid that attenuates interfering electromagnetic fields in the low frequency range. For example, a typical tri-shield coaxial cable typically includes a center conductor surrounded by a dielectric, an inner tape, a braid, an outer tape, and a jacket. Similarly, a typical quad-shield coaxial cable includes the same layers as a tri-shield coaxial cable, with an additional braid between the outer tape and the jacket.

Prior to the manufacture of a tri-shield coaxial cable, the inner and outer tapes are each shaped as a flat ribbon. During the manufacture of the cable, the inner tape is folded around the dielectric such that the two edges of the inner tape overlap one another to form a straight seam that runs the length of the cable. The braid is next formed around the inner tape, after which the outer tape is folded around the braid such that the two edges of the outer tape overlap one another to form another straight seam that runs the length of the cable. Finally, the jacket is extruded around the outer tape.

After manufacture of the tri-shield coaxial cable, the ends of the cable must be terminated with cable connectors prior to installation. Prior to termination with a cable connector, a quarter-inch section of the center conductor must be exposed by removing all other layers. In addition, immediately adjacent to the quarter-inch section of the exposed center conductor, a quarter-inch section of the jacket and the outer tape must also be removed, thereby exposing a quarter-inch section of the braid. The braid is then folded back over the jacket so that a circular post (or similar structure) of a cable connector can be inserted between the inner tape and the braid.

The removal of the jacket can be accomplished relatively easily by circumscribing the jacket with the cutting edge of a cable preparation tool. The removal of the outer tape, however, is generally accomplished by locating the seam of the outer tape and separating the seam by pulling the two overlapping edges of the seam completely apart. Once the seam is separated, the outer tape can then be torn off the coaxial cable using the outer jacket as a tearing guide.

One difficulty with the removal of the outer tape is identifying the position of the seam. In particular, the relative thinness of the outer tape tends to make the seam difficult to locate, especially where a cable technician is accomplishing cable termination in low-lighting conditions.

### SUMMARY OF SOME EXAMPLE EMBODIMENTS

In general, example embodiments of the present invention relate to shielding seam location in a coaxial cable. At least some example coaxial cables include an outer tape surrounded by a jacket. During coaxial cable termination, a portion of the outer tape must be removed. Removal of the outer tape is generally accomplished manually by locating the seam of the outer tape, separating the seam by pulling the two overlapping edges of the seam completely apart, and tearing the outer tape off the coaxial cable using the outer jacket as a tearing guide.

At least some example embodiments include a means for visibly manifesting the location of the seam of an outer tape in a coaxial cable. The means for visibly manifesting the location of the seam enables the location of the seam of the outer tape to be detected by a quick visual inspection of the outer tape after a jacket of the coaxial cable has been removed. The means for visibly manifesting the location of the seam is particularly helpful to cable technicians during cable termination.

In one example embodiment, a coaxial cable includes a center conductor surrounded by a dielectric, an inner conductive tape surrounding the dielectric, a conductive braid surrounding the inner conductive tape, an outer conductive tape surrounding the conductive braid, and a jacket surrounding the outer conductive tape. The outer conductive tape includes an aluminum layer, a seam in which two edges of the aluminum layer overlap one another, and means for visibly manifesting the location of the seam.

In another example embodiment, a coaxial cable includes a center conductor surrounded by a dielectric, an inner conductive tape surrounding the dielectric, a conductive braid surrounding the inner conductive tape, an outer conductive tape surrounding the conductive braid, and a jacket surrounding the outer conductive tape. The outer conductive tape includes a polymer layer, an aluminum layer adjacent to the polymer layer, and a seam in which two edges of the aluminum and polymer layers overlap one another. At least a portion of the seam has a visibly perceptible characteristic that contrasts with the surrounding surface of the outer conductive tape.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example coaxial cable that terminates on one end with an example connector and that is prepared for termination on the other end with another example connector;

FIG. 1B is a cross-sectional view of the example coaxial cable of FIG. 1A;

FIG. 1C a is perspective view of a portion of the coaxial cable of FIG. 1A with portions of each layer cut away; and

FIG. 1D is another cross-sectional view of the example coaxial cable and one of the example connectors of FIG. 1A.

### DETAILED DESCRIPTION OF SOME EXAMPLE EMBODIMENTS

Example embodiments of the present invention relate to shielding seam locations in a coaxial cable. In the following detailed description of some example embodiments, reference will now be made in detail to specific embodiments of the present invention, examples of which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Coaxial Cable

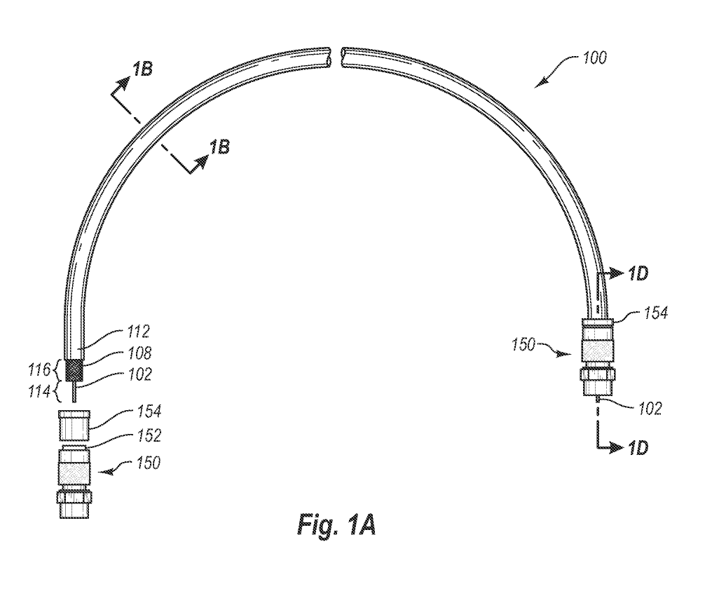

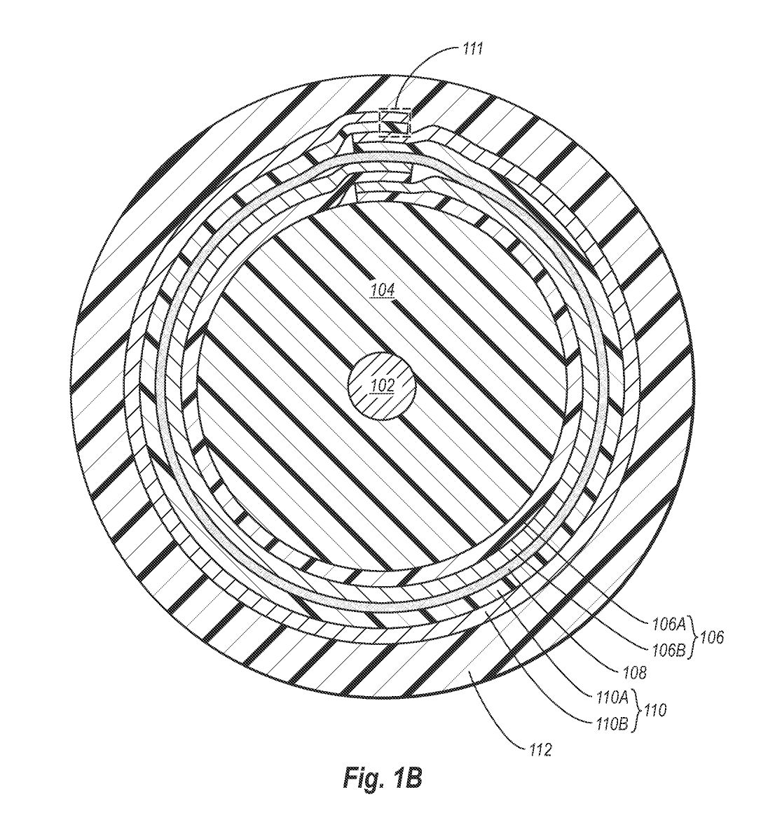

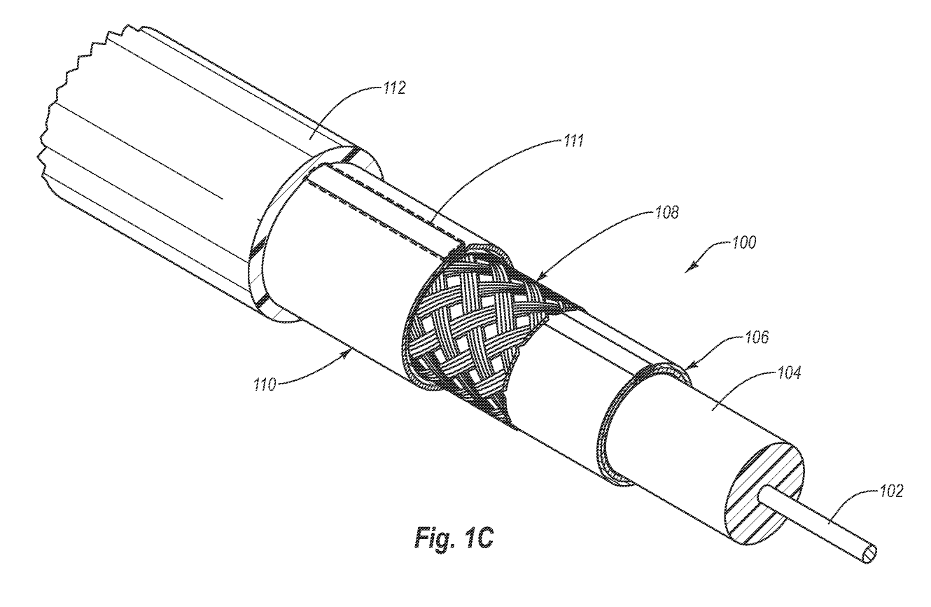

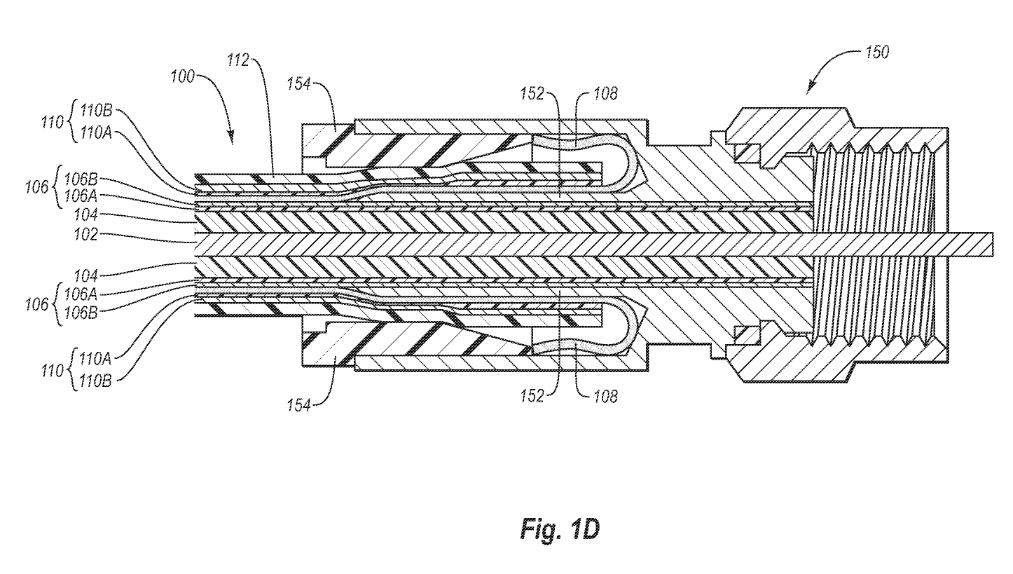

With reference first to FIG. 1A, an example coaxial cable 100 is disclosed. The example coaxial cable 100 can be any type of coaxial cable including, but not limited to, 50 Ohm and 75 Ohm coaxial cable. As disclosed in FIG. 1A, the example coaxial cable 100 is terminated on the right side of FIG. 1A with an example connector 150, and is prepared for termination on the left side of FIG. 1A with a second identical connector 150, as discussed in greater detail below. Although connectors 150 are disclosed in FIG. 1A as F-type male connectors, it is understood that cable 100 can also be terminated with other types of male and/or female connectors (not shown).

With continuing reference to FIG. 1A, and with reference also to FIGS. 1B and 1C, the coaxial cable 100 is a tri-shield coaxial cable that generally includes a center conductor 102 surrounded by a dielectric 104, an inner tape 106 surrounding the dielectric, a braid 108 surrounding the inner tape 106, an outer tape 110 surrounding the braid 108, and a jacket 112 surrounding the outer tape 110. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers. Each of these components of the example coaxial cable 100 will now be discussed in turn.

The center conductor 102 is positioned at the core of the example coaxial cable 100. The center conductor 102 is configured to carry a range of electrical current (amperes) as well as propagate an RF/electronic digital signal. In some example embodiments, the center conductor 102 is formed from solid copper, copper-clad aluminum (CCA), copper-clad steel (CCS), or silver-coated copper-clad steel (SCCCS), although other conductive materials are possible. For example, the center conductor 102 can be formed from any type of conductive metal or alloy. In addition, the center conductor 102 can be solid, hollow, stranded, corrugated, plated, or clad, for example.

The dielectric 104 surrounds the center conductor 102, and generally serves to support and insulate the center conductor 102 from the inner tape 106. Although not shown in the figures, a bonding agent, such as a polymer bonding agent, can be employed to bond the dielectric 104 to the center conductor 102. In some example embodiments, the dielectric 104 can be, but is not limited to, taped, solid, or foamed polymer or fluoropolymer. For example, the dielectric 104 can be foamed polyethylene (PE).

The inner tape 106 surrounds the dielectric 104, and generally serves to minimize the ingress and egress of high frequency electromagnetic fields to/from the center conductor 102. For example, in some applications, the inner tape 106 can shield against electromagnetic fields that are greater than or equal to about 50 MHz. As disclosed in the figures, the inner tape 106 is a laminate tape that includes a polymer layer 106A and an aluminum layer 106B. However, it is understood that the inner tape 106 can instead include, but is not limited to, the following layers: bonding agent/aluminum/polymer, bonding agent/aluminum/polymer/aluminum, or aluminum/polymer/aluminum, for example. It is understood, however, that the discussion herein of tape is not limited to tape having any particular combinations of layers.

The braid 108 surrounds the inner tape 106, and generally serves to minimize the ingress and egress of low frequency electromagnetic fields to/from the center conductor 102. For example, in some applications, the braid 108 can shield against electromagnetic fields that are less than about 50 MHz. The braid 108 can be formed from inter-woven, fine gauge aluminum or copper wires, such as 34 American wire gauge (AWG) wires, for example. It is understood, however, that the discussion herein of braid is not limited to braid formed from any particular type or size of wire.

The outer tape 110 surrounds the braid 108, and generally serves to further minimize the ingress and egress of high frequency electromagnetic fields to/from the center conductor 102, in combination with the inner tape 106. As disclosed in the figures, the outer tape 110 is a laminate tape that includes a polymer layer 110A and an aluminum layer 110B. However, it is understood that the outer tape 110 can instead include, but is not limited to, layers of aluminum/polymer/aluminum, for example.

The jacket 112 surrounds the outer tape 110, and generally serves to protect the internal components of the coaxial cable 100 from external contaminants, such as dust, moisture, and oils, for example. In a typical embodiment, the jacket 112 also functions to protect the coaxial cable 100 (and its internal components) from being crushed or otherwise misshapen from an external force. The jacket 112 can be formed from a relatively rigid material such as, but not limited to, polyethylene (PE), high-density polyethylene (HDPE), low-density polyethylene (LDPE), or linear low-density polyethylene (LLDPE), or some combination thereof. The jacket 112 may instead be formed from a relatively less rigid and more pliable material such as, but not limited to, foamed PE, polyvinyl chloride (PVC), or polyurethane (PU), or some combination thereof. The actual material or combination of materials used might be indicated by the particular application/environment contemplated.

### II. Example Coaxial Cable Termination

With reference now to FIG. 1D, and also with reference again to FIG. 1A, aspects of termination of the example cable 100 with the example connector 150 are disclosed. As disclosed on the left side of FIG. 1A, prior to the termination of the example coaxial cable 100 with the connector 150, both a first quarter-inch section 114 of the center conductor 102 and a second quarter-inch section 116 of the braid 108 must be exposed.

The second quarter-inch section 116 of the braid 108 is exposed by removing the jacket 112 and the outer tape 110. The removal of the jacket 112 can be accomplished relatively easily by circumscribing the jacket with the cutting edge of a cable preparation tool (not shown). However, the removal of the outer tape 110 must be accomplished manually by locating the seam of the outer tape 110, separating the seam by pulling the two overlapping edges of the seam completely apart, and tearing the outer tape 110 off the coaxial cable 100 using the outer jacket 112 as a tearing guide.

With reference again to FIGS. 1B and 1C, the outer tape 110 includes a means for visibly manifesting the location of the seam in order to assist a cable technician in the beginning step of removing the outer tape 110, namely, locating the seam of the outer tape 110. A variety of means may be employed to perform the function of visibly manifesting the location of the seam. Several example structural implementations of various means for visibly manifesting the location of the seam are disclosed herein. However, it should be understood that such structural implementations are disclosed herein solely by way of example and should not be construed as limiting the scope of the present invention in any way. Rather, any other structure or combination of structures effective in implementing the functionality disclosed herein may likewise be employed.

In one example embodiment, the means for visibly manifesting the location of the seam of the outer tape 110 is implemented as a chemical or polymer that presents a color, texture, or other visibly perceptible characteristic along a seam region 111 that contrasts with the surrounding surface of the outer tape 110. This visibly perceptible characteristic can be formed on the outer tape 110 along one or more edges and on one or more surfaces either prior to or subsequent to the inclusion of the outer tape 110 in the coaxial cable 100.

For example, at least a portion of the seam region 111 of aluminum layer 110B of the outer tape 110, beginning at the outer edge of the outer tape 110 after being overlapped, can be coated with, or otherwise include, a chemical or polymer which changes the color of some or all of the seam region 111. In one example, the seam region 111, beginning at the outer edge of the outer tape 110 after being overlapped, can be coated with a paint having a color that contrasts with the color of the surrounding regions of the aluminum layer 110B. For example, at least a portion of the seam region 111, beginning at the outer edge of the outer tape 110 after being overlapped, can be coated with a black paint to contrast with the surrounding aluminum layer 110B that is bright gray. In this example, the appearance of a black region surrounded on either side by bright gray regions would visually manifest the location of the seam of the outer tape 110 to a cable technician. The colors black and bright gray are examples only, and any other contrasting color combinations could be substituted in the above example. Likewise, a change in color contrast or brightness, such as where a color in the seam region 111 is simply lighter or darker, could also be substituted in the above example. Further, a glow-in-the-dark color can be employed in the seam region 111.

Alternatively, at least a portion of the seam region 111 of the aluminum layer 110B of the outer tape 110, beginning at the outer edge of the outer tape 110 after being overlapped, can be coated with, or otherwise include, a chemical or polymer which changes the texture of some or all of the seam region 111. For example, the texture of the seam region 111 can be changed from being smooth and reflective to being rough and dull. In this example, the regions of the aluminum layer 110B that surround the seam region 111, beginning at the outer edge of the outer tape 110 after being overlapped, continue to have a smooth and reflective texture. In this example, the appearance of a rough and dull region surrounded by smooth and shiny regions would visually manifest the location of the seam of the outer tape 110 to a cable technician. The textures rough and dull and smooth and shiny are examples only, and any other contrasting texture combinations could be substituted in the above example.

More generally, anything that visually distinguishes the seam region 111 from the regions of the aluminum layer 110B that surround the seam region 111 can be employed and the scope of the invention is not limited to the disclosed examples. Likewise, a combination of visibly perceptible characteristics, such as color and texture, can be used to visibly manifest the location of the seam of the outer tape 110.

In each of the above examples, the location of the seam of the outer tape 110 can be detected by a quick visual inspection of the outer tape 110 after the jacket 112 has been removed. The means for visibly manifesting the location of the seam is particularly helpful to cable technicians where the cable termination is being accomplished in low-lighting conditions.

As disclosed in FIGS. 1A and 1D, once the quarter-inch section 116 of the braid 108 is exposed, the exposed portion of the braid 108 can then be folded back over the outside of the jacket 112 so that a circular post 152 (or similar structure) of the cable connector 150 can be inserted between the inner tape 106 and the braid 108. Finally, a wedge portion 154 of the connector 150 can be slid down the coaxial cable 100 to firmly attach the connector 150 to the coaxial cable 100.

It is noted that the tri-shield coaxial cable 100 disclosed herein is just one example environment where the means for visibly manifesting the location of a seam disclosed herein can be employed. For example, the shielding seams location disclosed herein can also be employed in a quad-shield coaxial cable that includes an additional braid between the outer tape and the jacket of the cable.

It is further noted that the means for visibly manifesting the location of the seam disclosed herein can be employed with, or replaced by, other means for manifesting the location of the seam. These other means for manifesting the location of the seam can include means for tactily manifesting the location of the seam, such as a roughened region that contrasts with surrounding smooth regions and is therefore perceptible by touching the contrasting regions. These other means for manifesting the location of the seam can also include means for physically manifesting the location of the seam, such as physical means that is perceptible to a seam-locating tool that is capable of locating the seam through a visible, tactile, or other physical manifestation.

The example embodiments disclosed herein may be embodied in other specific forms. The example embodiments disclosed herein are to be considered in all respects only as illustrative and not restrictive.

What is claimed is:

1. A coaxial cable comprising:
a center conductor surrounded by a dielectric;
an inner conductive tape surrounding the dielectric;
a conductive braid surrounding the inner conductive tape;
an outer conductive tape surrounding the conductive braid, the outer conductive tape comprising:
an aluminum layer;
a seam in which two edges of the aluminum layer overlap one another; and
means for visibly manifesting the location of the seam; and
a jacket surrounding the outer conductive tape.

2. The coaxial cable as recited in claim 1, wherein the means for visibly manifesting the location of the seam comprises a chemical or polymer which changes the color of the aluminum layer proximate to the seam.

3. The coaxial cable as recited in claim 1, wherein the means for visibly manifesting the location of the seam comprises a chemical or polymer which changes the texture of the aluminum layer proximate to the seam.

4. The coaxial cable as recited in claim 1, wherein the outer conductive tape further comprises a polymer layer adjacent to the aluminum layer and opposite the means for visibly manifesting the location of the seam.

5. The coaxial cable as recited in claim 4, wherein the outer conductive tape further comprises a second aluminum layer adjacent to the polymer layer and opposite the aluminum layer.

6. The coaxial cable as recited in claim 1, further comprising a bonding agent bonding the dielectric to the center conductor.

7. The coaxial cable as recited in claim 1, wherein the inner conductive tape comprises a second polymer layer adjacent to a second aluminum layer.

8. The coaxial cable as recited in claim 7, wherein the inner conductive tape further comprises a third aluminum layer adjacent to the second polymer layer and opposite the second aluminum layer.

9. The coaxial cable as recited in claim 8, wherein the inner conductive tape further comprises a bonding agent adjacent to either the second aluminum layer or the third aluminum layer.

10. The coaxial cable as recited in claim 1, wherein the outer conductive tape further comprises means for tactily manifesting the location of the seam.

11. A coaxial cable comprising:
a center conductor surrounded by a dielectric;
an inner conductive tape surrounding the dielectric;
a conductive braid surrounding the inner conductive tape;
an outer conductive tape surrounding the conductive braid, the outer conductive tape comprising:
a polymer layer;
an aluminum layer adjacent to the polymer layer;
a seam in which two edges of the aluminum and polymer layers overlap one another, at least a portion of the seam having a visibly perceptible characteristic that contrasts with the surrounding surface of the outer conductive tape; and
a jacket surrounding the outer conductive tape.

12. The coaxial cable as recited in claim 11, wherein the visibly perceptible characteristic comprises a color of the aluminum layer proximate to the seam.

13. The coaxial cable as recited in claim 11, wherein the visibly perceptible characteristic comprises a texture of the aluminum layer proximate to the seam.

14. The coaxial cable as recited in claim 11, wherein the outer conductive tape further comprises a polymer layer adjacent to the aluminum layer and opposite the visibly perceptible characteristic.

15. The coaxial cable as recited in claim 11, wherein the outer conductive tape further comprises a second aluminum layer adjacent to the polymer layer and opposite the aluminum layer.

16. The coaxial cable as recited in claim 11, further comprising a bonding agent bonding the dielectric to the center conductor.

17. The coaxial cable as recited in claim 11, wherein the inner conductive tape comprises a second polymer layer adjacent to a second aluminum layer.

18. The coaxial cable as recited in claim 17, wherein the inner conductive tape further comprises a third aluminum layer adjacent to the second polymer layer and opposite the second aluminum layer.

19. The coaxial cable as recited in claim 18, wherein the inner conductive tape further comprises a bonding agent adjacent to either the second aluminum layer or the third aluminum layer.

20. The coaxial cable as recited in claim 11, wherein at least a portion of the seam further has a tactily perceptible characteristic that contrasts with the tactile characteristics of the surrounding surface of the outer conductive tape.
